(19) United States
(12) Patent Application Publication
(10) Pub. No.: US 2022/0179059 A1
(43) Pub. Date: Jun. 9, 2022

(54) OBJECT TRACKING USING BEAT SIGNAL FREQUENCY AND PHASE

(71) Applicant: Facebook Technologies, LLC, Menlo Park, CA (US)

(72) Inventors: Dustin Jeffrey Gordon Krogstad, Chino, CA (US); Riccardo DeSalvo, Sadena, CA (US); Joseph Minh Tien, Alhambra, CA (US); Omar Mikhail IIagan Perez, Gardena, CA (US); Fereydoun Daneshgaran, La Crescenta, CA (US); Paolo Mattera, Benevento (IT); Roberto Parente, Cerreto Sannita (BN); Vincenzo Galdi, Benevento (IT)

(21) Appl. No.: 17/116,199

(22) Filed: Dec. 9, 2020

(51) Int. Cl. G01S 13/36; G01S 13/34; G06F 3/01

(52) U.S. Cl. CPC G01S 13/36; G06F 3/011; G01S 13/343

(57) ABSTRACT

An example device may include a transmitter, such as a radio-frequency (RF) transmitter, a receiver and a controller. The receiver may include a mixer that generates a beat signal from a received signal and a local oscillator signal. A transmitted signal may include a linear frequency ramp and may be incident on an object, inducing the received signal. The device may include a controller configured to detect a frequency and phase of the beat signal. The device may determine an absolute distance to the object using the beat frequency and a distance component using the beat signal phase. The distance component may be used to increase the precision of an object distance measurement relative to the absolute distance alone. The distance component may be used to detect relatively small movements of the object, such as micron-scale movements. Various other methods, systems and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a simplified representation of a device determining an object distance.

FIG. 2 shows a schematic of a device configured to determine an object distance, according to some embodiments.

FIG. 3 shows a further schematic of a device configured to determine an object distance, according to some embodiments.

FIG. 4 shows representative examples of a transmitted signal and a received signal, from which a beat signal may be formed by the device according to some embodiments.

FIG. 5 shows a simplified schematic of a waveform generator that may be used in a RF transmitter, according to some embodiments.

FIG. 6 shows a schematic of an example transponder circuit, according to some embodiments.

FIG. 7 shows a schematic of a circuit configured to determine a beat signal frequency in a device, according to some embodiments.

FIG. 8 shows an example beat signal in the time domain, according to some embodiments.

FIG. 9 shows the repeatability of time period measurements for a beat signal.

FIGS. 10A-10B illustrate changes in the beat signal phase for micron-scale changes in the object distance.

FIG. 11 shows further example phase measurement results.

FIG. 12 illustrates a method of determining an object distance, according to some embodiments.

FIG. 13 illustrates a method of tracking object motion, according to some embodiments.

FIG. 14 is an illustration of exemplary augmented-reality glasses that may be used in connection with embodiments of this disclosure.

FIG. 15 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and are described in detail herein. However, the exemplary embodiments described herein are not intended to be limited to the particular forms disclosed. Rather, the present disclosure covers all modifications, equivalents and alternatives falling within the scope of the appended claims.

### DETAILED DESCRIPTION OF EXEMPLARY EMBODIMENTS

Wearable artificial reality devices may enable users to augment reality and/or combine certain aspects of reality with those of the virtual world. The provision of realistic virtual reality or augmented reality environments may require accurate and rapid tracking of user movements. Devices with improved measurement precision and faster data acquisition and/or analysis times would be very useful for achieving immersive virtual environments.

The present disclosure is generally directed to devices and associated systems and methods. As is explained in greater detail below, embodiments of the present disclosure include devices that may be configured to determine a distance from the device to an object. In some examples, the object distance may be determined from the frequency of a beat signal (e.g., by determining a beat period in the time domain). The object distance may include an absolute distance determined from the beat frequency. The object distance may also include a distance component determined from the phase of the beat signal. Precise changes in the object distance may be determined by measuring changes in the distance component determined from the phase of the beat signal. In some examples, changes in the object distance may be determined with a precision of less than 10 microns.

Features from any of the embodiments described herein may be used in combination with one another in accordance with the general principles described herein. These and other embodiments, features and advantages will be more fully understood upon reading the detailed description in conjunction with the accompanying drawings and claims.

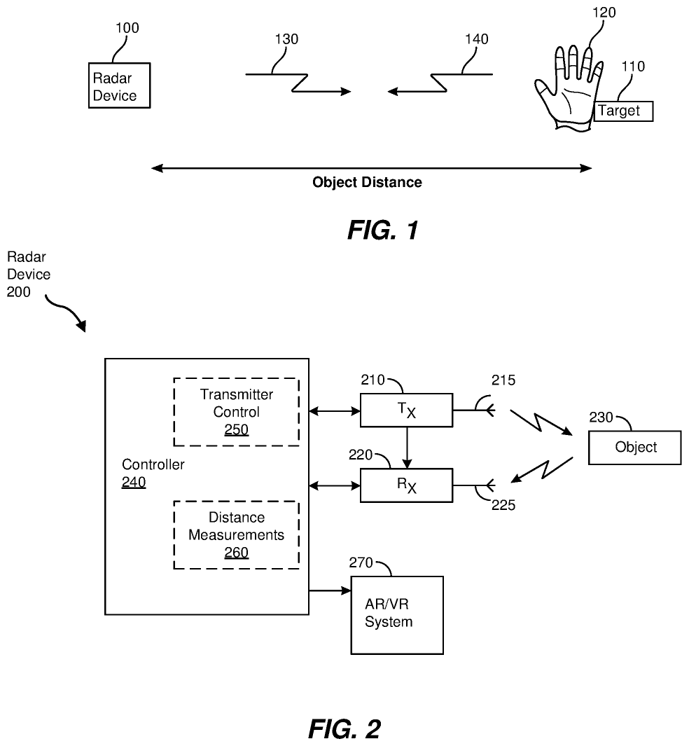

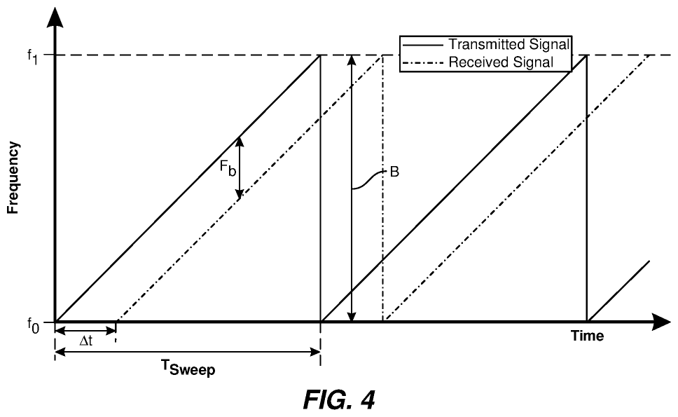

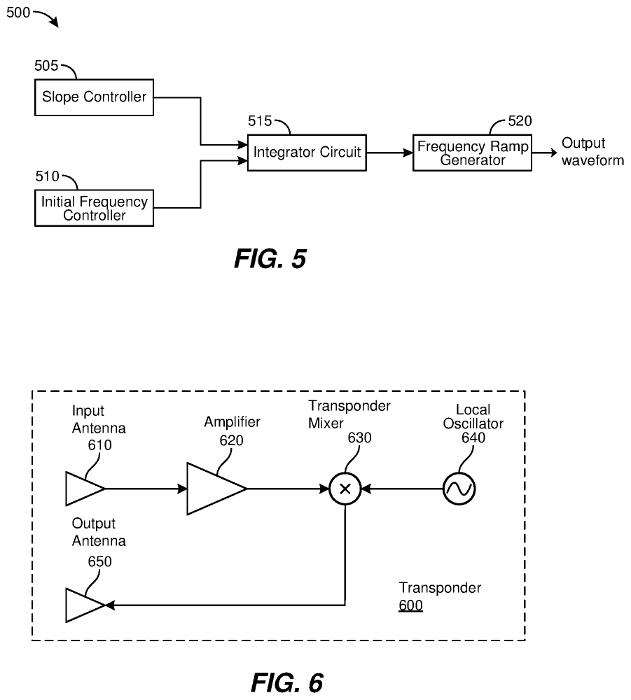

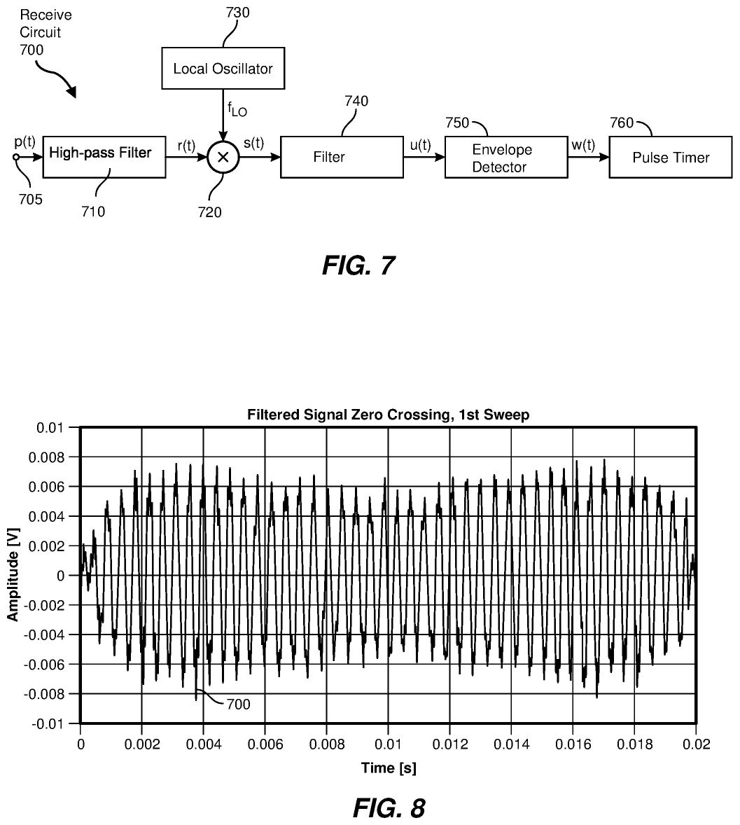

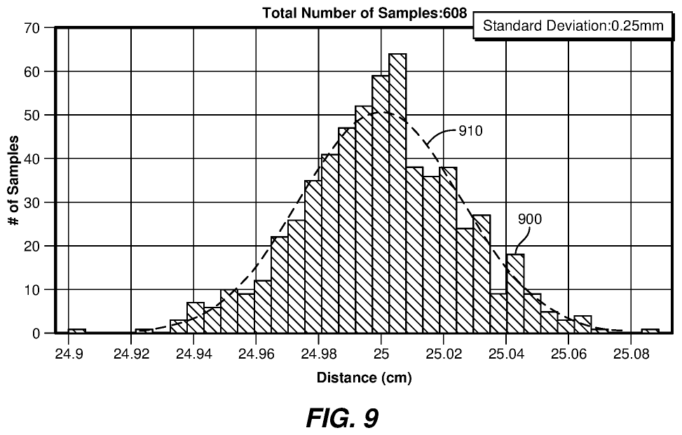

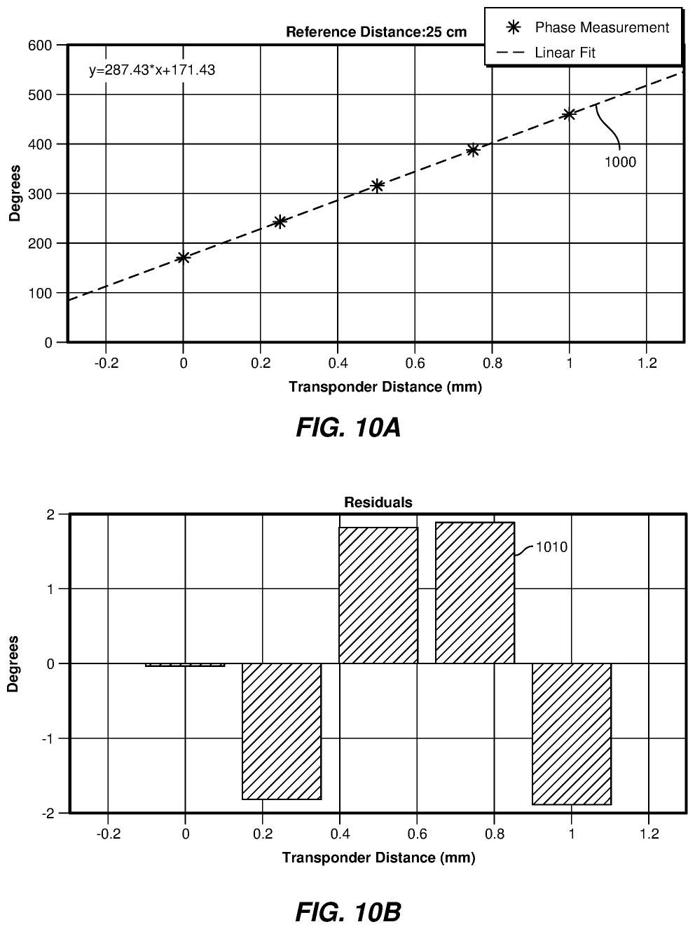

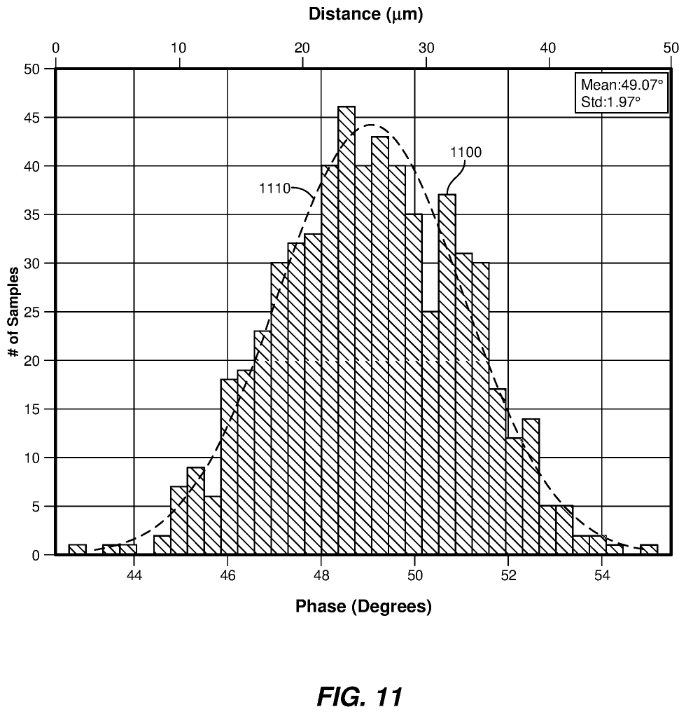

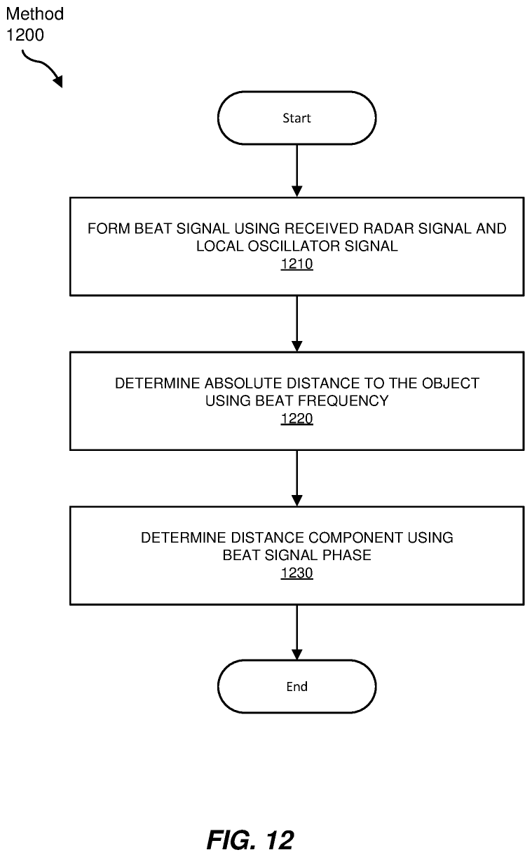

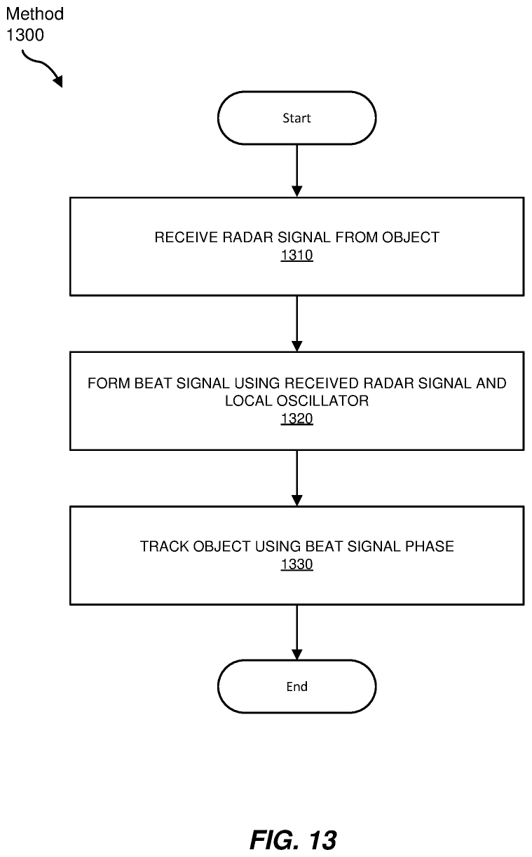

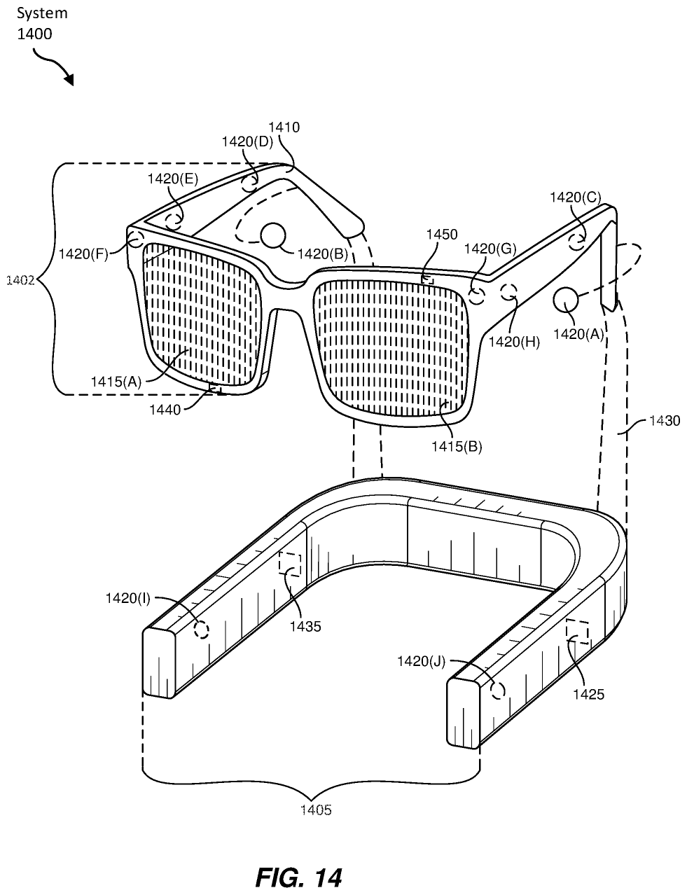

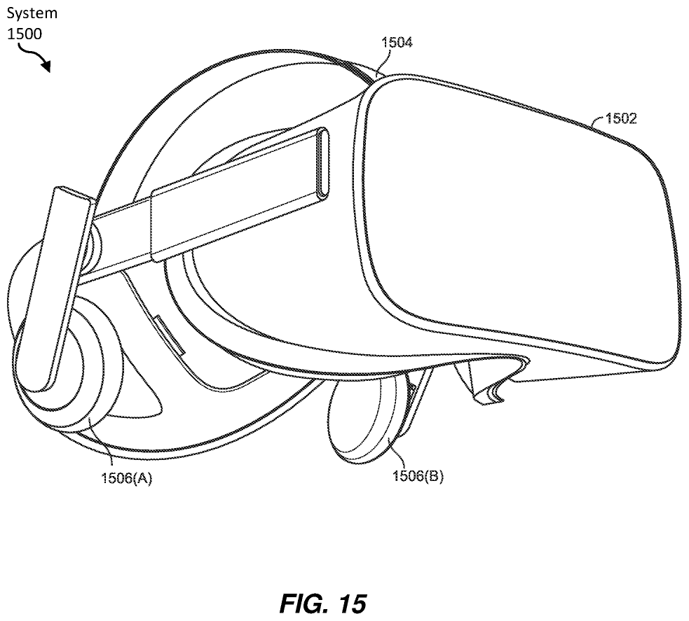

The following provides, with reference to FIGS. 1-15, detailed descriptions of devices, systems and methods. FIGS. 1-3 show example configurations of a device that may be configured to determine an object distance using the frequency and phase of a beat signal. FIG. 4 shows example transmitted and received signals. FIG. 5 shows an example waveform generator that may be used in the transmit circuit of a RF transmitter. FIG. 6 shows an example transponder. FIG. 7 shows a further example receive circuit. FIGS. 8-9 show an example beat signal in the time domain and excellent repeatability of time period measurements. FIG. 10A shows the measured linear dependence of the beat signal phase as a function of submillimeter variation in the active target distance. FIG. 10B and FIG. 11 illustrate changes in the beat signal phase due to noise for micron-scale determination of the object distance. FIGS. 12 and 13 illustrate example methods related to determining an object distance. FIG. 14-15 show exemplary augmented-reality devices that may be used in connection with embodiments of this disclosure.

As described in more detail below, an example device may include a transmit circuit (e.g., a radio-frequency (RF) transmit circuit), a receive circuit (e.g., an RF receive circuit), and a controller. The transmit circuit may include a waveform generator and an amplifier. The receive circuit may include a receive antenna, an amplifier, one or more filters, a mixer and a digital-to-analog converter. The receive circuit may be configured so that the mixer generates a beat signal based on a received signal detected by the receive antenna and a local oscillator signal. The local oscillator signal may be based on the signal generated by the waveform generator of the transmit circuit.

In some examples, the controller may be configured to determine a beat frequency, a beat signal phase and an object distance using the beat frequency and the beat signal phase. The beat frequency and beat signal phase may be determined by a controller, including one or more processors, based on an analysis of the beat signal. In some examples, the analysis of the beat signal does not include Fourier analysis. In some examples, the frequency and/or phase of the beat signal may be determined by time-domain analysis of the beat signal.

FIG. 1 shows a simplified schematic showing device 100 and object 110 (or “target”), that may include a transponder supported by body part 120 (e.g., a hand). The term “target” may refer an object of particular interest or an object that contributes to the received RF signal. The figure is not to scale. Device 100 generates a transmitted RF signal (such as a radar signal, shown illustratively at 130) and detects a received RF signal shown at 140. The distance between device 100 and object 110 may be referred to as the object distance, target distance or range. In some examples, the device 100 may be a radar device including a radar transmitter and a radar receiver.

FIG. 2 shows a schematic of a device 200 that may be configured to determine an object distance. Device 200 includes a RF transmitter 210 (denoted Tx), a RF receiver 220 (denoted Rx) and a controller 240. Device 200 (e.g., an RF device such as a radar device) may be configured to determine an object distance between device 200 and object 230 and may provide object distance and/or object location data to augmented reality and/or virtual reality system 270.

The arrow shown directed from RF transmitter 210 to RF receiver 220 indicates that transmit circuit 210 may provide a waveform signal used to generate the local oscillator signal to a mixer in the receive circuit. This aspect is described in more detail below.

Controller 240 may include one or more processors. Controller 240 may be configured to control the transmit antenna (250). For example, the controller may be configured to initiate generation of the transmitted signal (such as a transmitted RF signal), control the frequency ramp slope or activate/shutdown one or more transponders. The controller may also be configured to provide a measurement of the object distance (260). The object distance may be determined from the frequency and phase of a beat signal provided to controller 240 by RF receiver 220. These and other aspects are described in more detail below. In some examples, a device may be a component of an augmented reality and/or virtual reality system. One or more object distances may be determined using a device (and optionally using other sensor data) and may be used to determine the object location. An example device may include one or more transmitters and one or more receivers. Additional transmitters and/or receivers, in combination with beat signal phase measurements, may greatly improve position determination for one or more objects in the environment of a user.

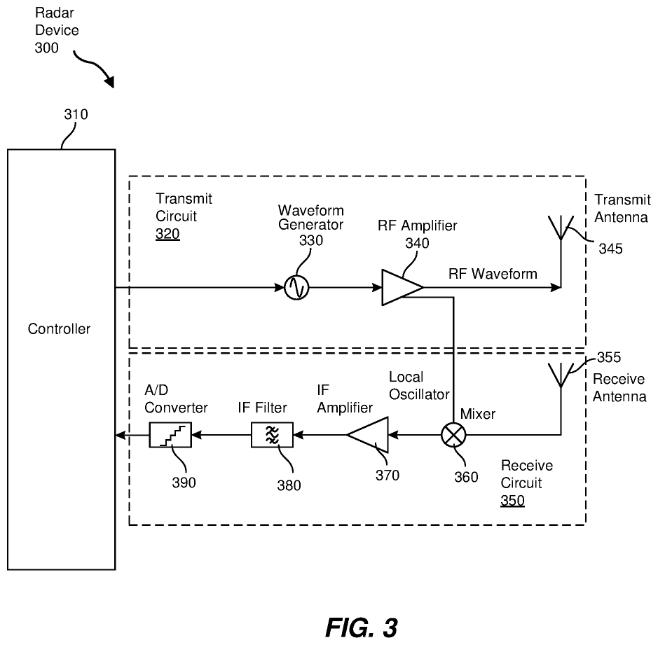

FIG. 3 shows a further schematic of a device 300, including controller 310, transmit circuit 320 and receive circuit 350. Transmit circuit 320 includes waveform generator 330, RF amplifier 340 and transmit antenna 345. The waveform generator 330 may generate a frequency ramp signal, which is amplified by RF amplifier 340 to provide an amplified RF waveform. The amplified RF waveform is passed to the transmit antenna 345 to generate the transmitted signal, which may be incident on the object (not shown).

The interaction between the transmitted signal and the object (not shown) may result in the received RF signal that is returned to the device. Receive circuit 350 may include receive antenna 355, mixer(s) 360, intermediate frequency (IF) amplifier 370, IF filter 380 and analog-to-digital (A/D) converter 390. The received signal, which may be a received RF signal, is detected by receive antenna 355 and passed to mixer 360, which also receives a local oscillator signal. In this example, the local oscillator signal may be based on a radio-frequency (RF) waveform from the transmit circuit. The mixer output from mixer 360 is amplified by IF amplifier 370 and passes through IF filter 380, to produce an analog signal whose envelope is the beat signal. A/D converter 390 produces a digitized version of the beat signal that may be sent to the controller 310 for analysis. In some examples, a receive circuit may include one or more mixers. For example, a receive circuit may include a mixer to remove the carrier frequency from the detected signal, and an additional mixer to generate the beat signal. A device may include multiple receive circuits (e.g., including multiple circuits each including one or more circuit elements such as 355, 360, 370, 380 and 390, discussed above), and a device may be configured to simultaneously track multiple targets.

Controller 310 may be configured to determine the frequency and phase of the beat signal, determine the absolute distance to the object based on the frequency of the beat signal and determine a differential distance component to the object using the phase of the beat signal. Additionally, the beat frequency and subsequently the beat signal phase may be used in tandem in an example method as follows: the beat frequency may be used to measure the distance to target to within half a wavelength of the center frequency; and then the beat signal phase may be used to further increase the range precision, for example, to a small fraction (e.g., one tenth) of the radio-frequency wavelength. The controller may also be configured to track the beat signal phase over a time period. Changes in the beat signal phase may be used to detect motion of the object within the environment. In some examples, the controller may use beat signal phase measurements to track object motion and/or detect object speed with relatively high precision, compared with the use of frequency measurements alone.

Phase measurements may be used to measure a change or increment in the object distance determined from beat frequency measurements. This change in distance may be referred to as a differential distance component. An initial beat frequency measurement may be used to determine an absolute distance to an object, and phase measurements then allow changes in the object distance to be detected with much better precision than given by frequency measurements alone. Example applications include improved hand tracking, finger motion detection, gesture detection, and detection of intended user inputs such as control inputs or data entry relating to real and/or virtual objects and devices.

Controller 310 may receive the beat signal as a digitized signal. The beat signal frequency (which may also be referred to as the beat frequency for conciseness) may be determined in the time domain by determining the time difference between threshold crossing points (e.g., zero crossing points), for example, using a timing readout circuit such as a pulse timer. The beat signal phase may be determined as a beat signal amplitude measurement, for example, relative to a reference time such as a reference timed based on a reference signal. A reference time may be based on, for example, a threshold-crossing point (such as a zero-crossing point) of the local oscillator signal. For example, the amplitude of the beat signal may be determined at the same time as a zero-crossing point of the local oscillator signal or at a particular time increment later.

The phase of the beat signal may be determined using one or more approaches, or a combination thereof, such as zero-crossing measurements or a template fitting approach. A section of the beat signal may be fitted using a template to determine the beat signal phase.

In some examples, the controller 310 may be configured to determine a relatively coarse distance to the object to within half a wavelength of the transmitted signal chirp center frequency using the frequency of the beat signal, and a finer distance component to the object to within a small fraction of a wavelength using the phase of the beat signal. In some examples, there may be a linear relationship between the frequency of the beat signal and the object's distance and the absolute distance may be determined using this linear relationship. The fine distance component determined by the phase measurement may cycle through repeated values as the object distance changes. In some examples, the distance component may be used to increase the precision of the object distance determination beyond that measurable using the beat frequency alone. Relatively small changes in the object distance (such as an object distance change of less than 10 microns) may induce sufficiently large changes in the beat signal phase to be easily detected, but relatively small and difficult to detect changes in the beat frequency. Hence, the beat signal phase may be used to detect relatively small changes in the object distance, compared with the motion sensitivity of using beat frequency measurements alone. This sensitivity may be particularly useful in augmented reality or virtual reality applications. An augmented reality or virtual reality system may respond to an intended user input by detecting a micron-scale motion, allowing appreciable improvements in system responsivity to user inputs. Improved precision in distance measurements may allow more precise determination of object location (e.g., using triangulation approaches), and improved user input detection (e.g., improved gesture detection). Intended user inputs may be detected earlier in time using beat signal phase measurements, as relatively fine motions may be detected (compared with the use of beat frequency alone). Beat signal phase measurements may allow faster device responses to user inputs, which may improve the immersive experience of AR/VR environments. Beat signal phase measurements may reduce the minimum physical amplitude required for gestures intended to control a device, which may reduce the possibility of repetitive strain injury in a user, and may allow user inputs to be received from relatively mobility-restricted users. For example, sub-millimeter movements may be reliably detected, and, in some examples, physical movements of less than 100 microns may be detected.

FIG. 4 shows an example transmitted signal and a received signal, as a function of frequency and time, that may be transmitted and received by an example device (such as example devices discussed above in relation to FIGS. 2 and 3). The frequency of the transmitted signal has a known time dependency. In this example, the transmitted signal has a linear frequency increase with time that may be referred to as a time-dependent linear frequency ramp (or more concisely as a frequency ramp). A frequency ramp may also describe a linear frequency decrease with time. The transmitted signal has an initial frequency (f₀) at the start of the sweep period and the frequency increases as a linear function of time until a final frequency (f₁) is reached at the end of the sweep period. The frequency range of the ramp is denoted B. The frequency may then be reset to the initial frequency in some way and the sweep may be repeated as many times as desired. The time duration of a single frequency ramp, or sweep time, is denoted as T_{Sweep}.

The time of flight delay due to the distance between the device and the object may result in a frequency difference between the received and transmitted signal frequencies at the time that the received signal arrives at the device. The frequency difference may arise, at least in part, due to the time lag between the transmission of a transmitted signal (e.g., a transmitted RF signal) to an object, and the detection of a corresponding received signal (e.g., a received RF signal), such as a reflected signal or otherwise returned signal. The delay between the transmitted signal and the corresponding received signal may be indicated as Δt. The received signal may have a frequency that is the same as the transmitted signal one round-trip time earlier, though in some examples the object may include a transponder that may introduce an additional frequency offset and may modify the beat signal frequency. This aspect is described in more detail below. The difference between the transmitted frequency and the received frequency at a particular time may be referred to as the beat frequency, labelled Fb in FIG. 4. The beat frequency may be determined by mixing two signals, one derived from the receive antenna output and the other being a local oscillator signal that may be based on the transmitted frequency at the time the received signal is detected. In this example, the beat frequency is proportional to the distance between the device and the object and the rate of change of the frequency ramp. In effect, the transmitted signal may change frequency according to an arbitrary but known time dependence during the time it takes for the corresponding received signal to be returned to the device, and the change in frequency may then be used to determine the time of flight for an RF signal to travel between the device and the object. The time-of-flight to the object may be assumed to be half the time required for the transmitted signal to reach the object from the device and the corresponding received signal to then be returned to the device.

A beat signal, formed using the received signal and a local oscillator (e.g., based on the frequency of the transmitted signal at the time the received signal is detected) has a frequency proportional to the object distance, for a linear frequency ramp. If an object distance is constant, the beat frequency (denoted fb) is generally constant. The mixer output signal may initially include various frequency components, such as the frequencies received by the mixer and their sums and differences.

The beat frequency may be the frequency difference between the received signal and an internal local oscillator signal. The local oscillator signal may be based on (and may be equal to) the transmitted signal frequency when the received signal is detected. The received signal frequency may be the transmitted signal frequency at an earlier time, when the transmitted signal incident on the object was sent. In some examples, an additional frequency offset may be introduced to the local oscillator signal frequency. In some examples, the local oscillator signal may be based on a delayed version of the transmitted signal frequency, which may add an additional contribution to the beat signal frequency. Increasing the beat signal frequency may increase the speed of time-domain beat signal frequency measurements, may reduce noise, and may help measurements of relatively small object distances.

FIG. 5 shows a simplified schematic of a waveform generator 500, which may be a component of a transmitter. For example, the waveform generator 500 may be used as waveform generator 330 shown in FIG. 3. The waveform generator 500 may be configured to generate frequency ramps, which may be amplified to provide the transmitted signal. The waveform generator 500 includes slope controller 505, initial frequency controller 510, integrator circuit 515 and frequency ramp generator 520. Slope controller 505 may generate a slope reference voltage typically in the form of a voltage pulse of appropriate shape, initial frequency controller 510 may generate an offset voltage determining the initial frequency of the ramp, integrator circuit 515 may generate a voltage ramp signal and frequency ramp generator 520 may generate a frequency ramp signal (a constant amplitude chirp signal). The slope reference voltage may be integrated by the integrator circuit and the offset voltage may be added to generate the voltage ramp signal. The slope reference voltage profile may be dynamically adjusted to modify the slope of the voltage ramp signal (e.g., expressed in V/s or any convenient unit) and the offset voltage may be adjusted to modify the initial voltage of the ramp voltage signal. The frequency ramp generator 520 may include a voltage-controlled oscillator and may generate the frequency ramp signal for the transmitting antenna. The frequency ramp signal may be an RF signal having a frequency variation based on the ramp voltage signal.

The waveform signal, including the frequency ramp signal output from the frequency ramp generator 520, may then be amplified and passed to a transmit antenna to generate the transmitted signal, for example, as discussed above in relation to the transmit circuit 320 of FIG. 3.

FIG. 6 shows a schematic of an example transponder circuit 600, including input antenna 610, amplifier 620, transponder mixer 630, local oscillator 640 and output antenna 650. The input antenna 610 detects the transmitted signal from the device and provides an input signal that is amplified by amplifier 620 and passed to transponder mixer 630, which may also receive the local oscillator signal from local oscillator 640. Transponder mixer 630 produces an output waveform that is passed to output antenna 650, to produce a transponder signal. The received signal at the device may include the transponder signal. The local oscillator and mixer are both optional in the transponder. In some examples, the transponder signal may have the same frequency as the transmitted signal from the device. However, the local oscillator may be used to introduce a frequency offset in the transponder signal frequency. The transponder signal may be greater than (or, in some examples, less than) the transmitted signal by a frequency offset equal to the transponder local oscillator frequency.

FIG. 7 shows an example schematic of a receive circuit 700 that may be part of a receiver and may be configured to produce the beat signal in the device. Receive circuit 700 may be used in a device similar to that discussed above in relation to FIG. 3. Receive circuit 700 includes antenna connection 705 (connected to the receive antenna, not shown), high-pass filter 710, mixer 720, local oscillator 730, filter 740, envelope detector 750 and pulse timer 760. The high pass filter 710 is optional and, for example, is not shown in the receive circuit 350 of FIG. 3. The filter 740 may include an IF filter, such as IF filter 380 discussed above in relation to FIG. 3. The pulse timer 760 may be part of the controller, part of the receive circuit or may be a separate circuit. In some examples, the function of the envelope detector may be provided by a square law detector, or by a second mixer that removes the transponder carrier frequency. The beat frequency may be the frequency of the envelope of the mixer output signal.

The operation of receive circuit 700 is now described in more detail. In FIG. 7, p(t) represents the received signal from the antenna, r(t) represents a filtered received signal, f_{LO} represents the local oscillator signal from internal local oscillator 730, s(t) represents the mixer output signal (e.g., which may include the input signal frequencies and their sum and difference), filter 740 may either use narrow-band filters or mix in the transponder's local oscillator frequency (which may be broadcast or re-generated in situ) or any other suitable technique, to isolate the signal from individual transponders, u(t) represents a filtered mixer signal and w(t) represents the envelope signal (e.g., after the device and transponder's local oscillator frequencies have been removed) that may correspond to the beat signal. In this example, the term beat signal may refer to the difference frequency component of the mixer output signal.

The received signal may be detected by a receive antenna (not shown) connected to antenna connection 705. The received signal may be passed through high-pass filter 710 to mixer 720, which also receives the internal local oscillator signal from local oscillator 730. Filter 740 may include a high-pass filter and/or a band-pass filter. Mixer 720 generates and outputs the mixer output signal, which may include components at the sum and difference of the local oscillator frequency and received RF signal frequency as well as the local oscillators from different transponders, and the relative beat frequencies. The mixer output signal may include radio-frequency components (e.g., at the internal local oscillator frequency, the received signal frequency and the sum of these frequencies), along with appreciably lower frequency components. The mixer output signal is filtered to eliminate the radio frequencies and similarly extract the beat signal encoded by a specific transponder's local oscillator frequency, and passed to an envelope detector which generates the envelope signal. This may remove the receiver (and possibly the transponder) local oscillator frequency components, so that the remaining component may represent a beat signal having a frequency that is the frequency difference between the local oscillator frequency and RF signal received from a specific transponder. The beat frequency may then be determined in the time domain by determining the time difference between threshold crossing points (e.g., zero crossing points) using pulse timer 760. In some examples, the envelope detector may not be needed, and the signal from the mixer may be analyzed by a combination of a comparator and pulse timer.

FIG. 8 shows an example beat signal 800 including a plurality of zero crossing points where the signal passes through a zero-amplitude level. The frequency of the beat signal may be determined from the beat period (i.e., the reciprocal of the beat frequency). The beat period may be determined by measuring the time between successive zero crossing points (or other corresponding threshold crossing points), which may correspond to one half the beat period or the entire beat period (e.g., if the direction of crossing is accounted for). Other techniques may also be used, including but not limited to matched filtering or template matching.

Conventionally, a beat frequency may be determined using a Fourier analysis of the beat signal. However, a Fourier analysis may involve a relatively long sample time for accurate results. In some examples, the use of a transponder to provide the received signal may greatly improve the signal-to-noise ratio of the received signal, improving the quality of the beat signal and allowing the beat frequency to be determined using approaches that do not use a Fourier analysis, such as zero crossing determinations that may be made over a measurement time period much less than needed for Fourier analysis. Other approaches to the determination of beat frequency and/or beat phase include matched filtering approaches such as template fitting.

Fast sub-millimeter precision of an object position may be achieved by determining the beat frequency in the time domain. Threshold-crossing times (e.g., zero-crossing times) may be detected and the time spacing between two or more threshold-level crossings of the beat signal may be used to determine the beat period and hence the beat frequency. This approach may provide significant signal analysis speed advantages over a fast Fourier transform (FFT) approach. The precision may be proportional to the number of periods observed. A large number of beat period measurements may be made within a small fraction of a millisecond, allowing averaging of a plurality of beat period measurements to improve the accuracy of an absolute object distance measurement. The frequency detector may be configured to determine the frequency of the beat signal based on a time interval between threshold crossings (e.g., zero-crossings or other threshold level crossings) of the beat signal, or other suitable approach. The beat signal may be analyzed in the time domain, without the use of a Fourier transform.

The returned (e.g., reflected) RF signal returned by the transponder to the device may be mixed with a local oscillator signal (e.g., based on the transmitted signal or a time and/or frequency offset version of the transmitted signal) to give the intermediate frequency (IF) signal. An IF signal may contain the beat signal and contributions from the RF components. After processing and filtering, the RF components may be removed, leaving the beat signal. In this context, the beat signal frequency may be the difference between transmitted and received frequencies, at the time of signal detection. The sum of radio frequencies will also be a radio frequency, which if necessary may be removed along with the other radio frequencies.

For example, the detected signal (e.g., from the receive antenna) may be rectified and then low-pass filtered to remove the HF (high frequency) components from the IF signal. The mixer output signal may contain frequency components corresponding to the sum and difference of the detected and different local oscillator frequencies, as well as the input frequencies. The mixer output signal may be filtered to selectively retain the specific difference frequency component, which may be termed the beat signal of a specific transponder. The term “reflected signal” (or “returned signal”) may be used to refer to any RF signal returned to the device from the object, and may include, for example, signals that are actively generated by a transmitter circuit within the transponder.

FIG. 9 shows the repeatability of a single beat period measurement showing a standard deviation of 0.25 mm for an object distance of 25 cm. This demonstrates that precise and very fast measurements can be made of an object's distance by determining the beat frequency from time domain measurements (e.g., using direct measurements of the beat time period by a timing circuit). A large number of sample measurements may be determined within a time period less than a millisecond. The figure shows a fit 910 to absolute distance data 900, determined using single beat time period measurements, showing a standard deviation in the absolute distance measurements of 0.25 mm. Hence, the absolute distance to an object may be determined with a precision of less than 1 mm using one or more beat frequency measurements. Even a single measurement is likely to be within 1 mm of the correct value of absolute distance and a plurality of measurements may provide sub-millimeter precision. In some examples, the transmitter frequency may be approximately 120 GHz, but other transmitter frequencies may be used. The positional resolution may be increased for higher frequency transmitted signals.

FIG. 10A shows the change in in beat signal phase for a target, as the object distance (also referred to as the target range) is increased in increments of 200 microns (0.2 mm). The data is well fitted by line 1000 and the slope of the line 1000 represents the sensitivity of the phase measurement with respect to target distance. Residuals 1010 are shown in FIG. 10B. The phase sensitivity was observed to be 287.4°/mm, using an RF carrier frequency of 119.8 GHz. At a target distance of 50 cm, the standard deviation (or precision) of the phase measurement may be as low as 2 degrees (discussed further below in relation to FIG. 11) and with a slope of 276.8°/mm and this corresponds to a target distance precision of 7.5 microns. These data show that a positional precision of less than 10 microns may be achieved, for example, with a transmitter frequency of approximately 120 GHz. However, other transmitter frequencies may be used.

FIG. 11 shows the results of example beat signal phase measurements, based on the same signal used in FIG. 9 for a fixed object distance. Phase measurements 1100 may be fitted using a model equation such as bell curve 1110. In this example, the mean phase angle is 49.07 degrees and the standard deviation is 1.97 degrees or approximately 2 degrees, or about 7 μm in length scale. The distance scale shown across the top of the graph represents changes in object distance (length scale in microns) corresponding to the beat signal phase change (in degrees) shown along the bottom. The ordinate represents the number of measurements. One or more beat signal phase measurements may be made for each object distance determination. The number of beat signal phase measurements made for each object distance measurement may be adjusted based on one or more parameters, such as desired precision (or accuracy), previously observed measurement precision, expected distance change, object motion (e.g., as observed using frequency and/or phase measurements), beat signal characteristics (e.g., frequency or noise characteristics), and the like.

Phase measurements may greatly increase the precision of object distance measurements. The beat frequency is inversely proportional to the effective time delay and may therefore change relatively slowly with changes in object distance. The beat signal phase may be determined using a substantially instantaneous amplitude measurement. A phase measurement may be much more sensitive to changes in object distance than a frequency measurement. For example, when a target moves by half a wavelength, 1.25 mm at 120 GHz, a full 360° change of the phase of the beat frequency may be observed. The object distance component obtained using phase measurements may be, for example, one or two orders of magnitude more precise than the absolute distance determined using the beat frequency.

A phase measurement may be made relative to a reference (e.g., a reference point on a reference signal, such as a threshold-crossing point of the local oscillator signal or the received signal, or in reference to previous phase measurements). The threshold-crossing point of a sinusoidal signal may change in a relatively large and easily detectable manner as the object distance changes within a half a wavelength interval (e.g., relative to a coarse distance determined using the beat frequency). In some examples, the beat signal phase may be determined by measuring a time delay between a threshold-crossing point of a reference beat signal and a threshold-crossing point of the actual beat signal. For example, the time between a zero-crossing point of the beat signal and the zero-crossing point of a reference beat during the same sweep may be determined.

An example device may use a center carrier frequency of approximately 120 GHz. In this example, the beat signal phase advances by 360°/1.25 mm or 288°/mm. Measuring the phase of the beat signal, along with the beat frequency, provides much higher precision in distance measurements than measuring the beat frequency alone.

The phase measurement may repeat identically after each full phase rotation (half a wavelength change in range). A phase measurement may only be useful if a coarse distance determined from the beat frequency may be determined with an accuracy less than half a wavelength (e.g., 1.25 mm @120 GHz). The beat frequency measured using the time domain method had sufficient precision to determine the object distance within half a wavelength. Combining the beat frequency measurements with a beat signal phase measurement then allows object distance determination with sub-millimeter accuracy.

FIG. 12 is a flow diagram of an exemplary method 1200 for determining an object distance using a device. The exemplary method 1200 includes forming a beat signal using a received RF signal (e.g., a radar signal) and a local oscillator signal (1210), determining a coarse distance to the object based on the beat frequency (1220) and determining a more precise distance component using a beat signal phase (1230). The object distance may be determined by combining the coarse distance and the refinement component. In some examples, rapid-fire determinations of the distance component may be used to detect and/or measure relatively small motions (speed) of the object, that in some examples may not be reliably detectable without the distance component measurements. Changes in the distance component may be used to track movements of the object (e.g., relative to an absolute distance determined using the beat frequency), and a movement of less than 10 microns (and in some examples, less than 5 microns) may be determined using the distance component measurements. The method may further include generating the transponder's local oscillator signal based on a transmitted (broadcast) RF signal.

Object speed may be determining using phase measurement repetition rate sufficiently high that the phase changes by less than one half wavelength per measurement. Radial speed may be determined from phase measurements without determining an absolute distance. For example, a movement of 1 m/s would rotate the phase by 360 degrees in 1.25 ms, so that measuring the distance at a repetition rate of 2 kHz would determine the speed. Other approaches such as the Doppler effect may be used, and may be combined with phase measurements.

FIG. 13 shows an exemplary method 1300 of detecting a motion of an object using a device. Method 1300 includes receiving an RF signal (e.g., a radar signal) from an object at the device (1310). The received signal may include a transponder signal from a transponder located on or otherwise linked to the object (or, e.g., a reflected transmitted signal). The method may further include forming a beat signal between the received RF signal and a local oscillator signal (1320) and tracking the object (e.g., detecting a movement of the object) using the beat signal phase (1330). In some examples, the movement of the object may be used to provide an input for a computerized system, such as a computer, an augmented reality device or a virtual reality device.

In some examples, one or more aspects of methods described herein may be performed by any suitable computer-executable code and/or computing system, such as the device controller. In some examples, one or more of the steps shown in FIG. 12 or 13 may represent an algorithm whose structure includes and/or is represented by multiple sub-steps. The devices described herein may perform various method steps in a variety of ways.

An example device, such as a frequency-modulated continuous wave (FMCW) radio frequency (RF) device (e.g., an FMCW radar device), may be used to measure a distance between the device and an object of interest by determining the time of flight (e.g., for a transmitted RF signal to reach an object and for the received RF signal to then return to the device). The transmitted frequency may be ramped at a fixed rate so that the frequency difference between the transmitted signal and the received signal (which may be determined as a beat frequency) may be proportional to the object distance. The beat frequency may be based on the change in the transmitted frequency that occurs after the transmitted signal is directed towards the object and before the received signal returns from the object to the device.

In some examples, a device may be configured to transmit an FMCW RF signal, such as an FMCW radar signal. A frequency-modulated transmitted signal may scan (e.g., sweep) over a range of frequencies, for example, between an initial frequency and an end frequency. The frequency of an FMCW transmitted signal may vary linearly with time, over period of time that may be termed the sweep time. The received signal may include one or more of a reflected, echoed and/or otherwise returned signal from an object on which the transmitted signal was incident. The object distance may be determined based at least in part on a frequency difference between the received signal frequency and a local oscillator frequency. The local oscillator frequency may be based on the transmitted frequency and may have a similar time dependence. An example device may combine (e.g., multiply) the received signal and the local oscillator signal and use a filter to isolate the difference frequency component that may be referred to as the beat signal. In some examples, such as for a transmitted signal with a linear frequency ramp, the beat frequency may be proportional to the object distance.

The received signal may be detected in response to the transmitted signal being incident on the object. For example, the received signal may be based on an interaction between the object (e.g., a transponder) and the transmitted signal, such as reflection, scattering or re-radiation at the same or a different frequency by the transponder. The transmitted signal may be incident on the transponder and the received signal may include a transponder signal generated by the transponder in response to the transmitted signal.

In some examples, a device may include an RF transmitter (e.g., a radar transmitter) configured to transmit a transmitted signal, an RF receiver (e.g., a radar receiver) configured to detect a received signal and determine a beat signal, and a controller configured to determine an object distance between the device and an object using the frequency of the beat signal and the phase of the beat signal. The device may include a mixer configured to provide a beat signal based on a local oscillator signal and the received signal and the mixer may be component of the receive circuit of the RF receiver. The device may include a frequency detector configured to determine a frequency of the beat signal and a phase detector configured to determine a phase of the beat signal and these aspects may be provided by the controller. For example, the frequency and phase of a digitized beat signal may be determined by one or more processors.

In some examples, the transmitted frequency may be a radio frequency (RF) signal, such as a radar frequency. In some examples, the transmitted signal may be in the gigahertz (GHz) range, for example, a transmitted signal with a frequency between approximately 1 GHz and approximately 300 GHz. In some examples, other values of transmitter frequency may be used, such as megahertz (MHz) frequencies (e.g., for outdoor applications), higher GHz frequencies, and/or terahertz (THz) frequencies.

In some examples, the beat frequency may be several (e.g., three or more) orders of magnitude lower than the transmitted frequency. For example, the beat frequency may be in the range of between approximately 100 Hz and approximately 10 MHz, for example, between 1 kHz and 1 MHz. In an example device receiver, the beat frequency may be based on the difference between the received frequency and the local oscillator frequency. In some examples, the beat signal may be digitized by an analog-to-digital (A/D) converter, and a controller including one or more processors may be used to analyze the beat signal.

An example mixer may produce signals having frequencies equal to the sum and difference of the input signal frequency and the local oscillator frequency. In an example device receiver, the local oscillator frequency may be based, and may be equal to, a present value of the transmitter frequency. In some examples, the local oscillator frequency may be based on a time-delayed (or offset) value of the transmitter frequency, for example, to increase the beat frequency.

The local oscillator frequency of an example transponder may be, for example, in the range of 10 kHz-100 MHz and may be used to shift (or “offset”) the frequency of the transponder signal, for example, by producing a transponder output signal higher or lower than the input signal. In some examples, the transponder output frequency may be higher or lower than the input frequency received by the transponder, and, in some examples, the frequency offset introduced by the transponder mixer may be used to identify the transponder. A frequency offset may be used to introduce a frequency increase of similar magnitude in the beat frequency formed in the device, that may improve the accuracy of short object distance measurements and/or may allow identification of the transponder.

In some examples, the mixer output signal may be rectified and then low-pass filtered to remove components at RF frequencies (e.g., components other than the difference frequency). The resulting beat signal may have a beat frequency based on the difference between the received signal frequency and local oscillator frequency. The beat signal may then be passed to a comparator set at a threshold voltage and configured to produces a square wave from the beat signal. The time between two successive rising edges may be determined and used as a measurement of the beat time period, from which the beat frequency may be determined (e.g., as the reciprocal of the beat time period). An absolute distance to the object may be determined by a single period measurement. A number of measurements may be averaged and/or the time period determined for one or more periods or half periods.

The object distance may be determined from the time delay between sending a transmitted signal that reaches the object and detecting a received signal from the object. The object may be a transponder. The beat frequency (as used herein, this may refer to the difference frequency component) is related to the time delay and the rate of change of transmitted frequency with time (e.g., the slope of a linear frequency ramp). The time delay may be the sum of the time taken for the transmitted signal to reach the object and the time taken for the received signal to return from the object to the device. This may be termed an out-and-back time delay. The object distance may then be determined using the time delay (e.g., using half the out-and-back time delay) and the speed of the RF signal (electromagnetic radiation), using the relationship that distance is the product of speed and time. Typically, the speed of light in air may be used, but an example device may also operate in other environments, such as in water. The appropriate speed (v) of electromagnetic radiation may be used to determine the distance to the object (e.g., v=c/n, where c is the speed of light in a vacuum and n is the refractive index at the RF frequency for the surrounding medium).

The transmitted signal may include one or more time-dependent frequency ramps. The frequency (as a function of time) of a transmitted signal may include a frequency ramp (sometime referred to as a frequency sweep) having a particular frequency range (e.g., from 120 GHz to 130 GHz, though other ranges may be used). In some examples, the transmitted signal may be a microwave signal (e.g., a millimeter wave signal of frequency between approximately 30 GHz and approximately 300 GHz), or a terahertz signal (e.g., 0.3 THz-30 THz). In some examples, a received RF signal may be within a similar frequency band as a transmitted RF signal. A frequency ramp (or sweep) may have a frequency range that corresponds to up to approximately 20% of the initial transmitted frequency (e.g., up to 10% of the initial transmitted frequency), though in some examples, the frequency range may be reduced, as discussed in more detail below.

Using a Fourier analysis approach, data from the full frequency range may be collected and then analyzed. However, a device configured to determine the beat signal time period, in the time domain, may determine the beat frequency from the time period before the frequency ramp is completed (e.g., before the transmitted frequency reaches the end frequency). The frequency ramp may then be ended immediately once the beat frequency is determined. This may reduce the data collection time, by not requiring further data collection once the beat frequency is determined and may also reduce transponder power requirements by reducing by reducing the proportion of the time that the transponder is active. This technique may be referred to as an adaptive threshold-crossing (e.g., zero-crossing) observation window. The transponder of interest may then be deactivated, the next transponder of interested may then be activated and another frequency ramp started to measure the object distance for the next transponder. Such approaches may reduce the interrogation duty cycle for one or more transponders and may facilitate powering transponders using energy harvesting approaches. In some examples, a transponder may be interrogated in less than 1 millisecond.

Using an adaptive threshold-crossing observation window may be particularly advantageous when determining relatively short object distances. For example, a user may bring a hand near their face and the beat frequency may decrease as the object distance decreases. The time between each threshold crossing (e.g., zero crossing) may increase and implementing an adaptive threshold-crossing observation window may prevent unnecessary delays when determining the beat frequency.

In some examples, the time required to obtain distance measurements may be reduced by increasing the speed of the frequency sweep. The time between the initial frequency and end frequency may be reduced, increasing the gradient of the frequency/time relationship. The initial frequency and/or end frequency may also be adjusted. In some cases, a particular transponder may be energized. An expected transponder frequency may be estimated, that may be based, for example, any transponder offset frequency or an estimated position of the transponder or associated body part. The ramp may then be centered around the expected transponder frequency and the ramp range may be set to a predetermined value. An example device may be configured to increase the rate of change of frequency versus time fora frequency ramp in order to reduce the time to determine an object distance. In some examples, a frequency ramp may be completed in a time period of approximately 1 millisecond or less.

The time to extract the beat frequency from the beat signal may be greatly reduced by one or more of various approaches, for example, by reducing the range of the frequency ramp, increasing the magnitude of the slope (Hz/second) of the frequency ramp, measuring the beat signal time period using zero crossings in time domain and ending the frequency ramp signal once sufficient zero crossings have been determined. Using a transponder to provide the received signal to the device may improve the signal-to-noise of the received signal. In some examples, the frequency ramp may be stopped as soon as the beat signal time period is determined from zero crossing detections (or other threshold level crossing detections) related to the beat signal. This may be particularly useful for lower target distances, as the beat frequency may decrease as the transponder moves closer to device. In some examples, a beat frequency may be determined by comparing a measured beat signal waveform with one or more reference beat signal waveforms corresponding to different beat frequencies.

In some examples, the rate of change of the beat frequency and/or a phase signal phase may be used to determine a motion speed of an object. The rate of change of the beat signal phase may improve the low speed sensitivity of motion speed determination, compared to use of the rate of change of beat frequency alone.

In some examples, a system may include a device and one or more transponders. A transponder may be located on body of a user, such as a limb, torso, finger, toe or other body part. A transponder may be located at a joint of body, such as the wrist, elbow, shoulder, knee, ankle, finger joint and the like. Unless specifically otherwise described, a finger may be the thumb. In some examples, a transponder may be located on an object, such as a controller, game object or any other object. A game object may be an object used in a game or represent one within an augmented or virtual reality environment. For example, a game object may be, include or represent a racket, club, ball, weapon (e.g., a light saber), cue, other inanimate object or animal. In some examples, one or more reference transponders may be located in a fixed location or associated with fixed objects. In this context, a fixed location may be fixed within a local frame of reference, such as the local physical environment of the user. A fixed location may include a location on the floor, nearby walls, doorways, windows, heavy objects or other relatively immobile objects within the local environment.

In some examples, a transponder may introduce a predetermined frequency offset to the received signal, sometimes termed the input signal, so that the output signal is offset by that amount relative to the input signal. The predetermined frequency offset may provide one or more advantages, such as allowing identification of the transponder and/or providing improved device accuracy for shorter object distances (e.g., by increasing the beat frequency).

A transponder may be secured to an additional wearable device worn on a body part of the user. Transponder(s) may be located at one or more locations on a glove, for example, at a fingertip, knuckle, other joint such as a finger joint, wrist and the like, palm, back of the hand and the like. For example, a transponder may be secured to the fingertip of an artificial reality glove worn by the user. A controller may be configured to determine a location of one or more fingertips or other body parts, within the physical environment. Additionally or alternatively, the controller may determine that the user's fingertip has changed location (e.g., relative to the physical environment and/or relative to one or more devices). The detected motion of the fingertip or other body part may be used determined an intended user input into a computerized device.

In some examples, a transponder may be located inside the clothing of a user. A radio frequency of, for example, between approximately 60 GHz and approximately 125 GHz may pass through dry clothing with attenuation insufficient to prevent object distance measurements. For example, a transponder may be located on a wristband that may be visually concealed, at least in part, by a sleeve.

In some examples, a transponder may be secured at a stationary location within the physical environment. For example, an example transponder may be part of an array and/or group of transponders that are positioned at various locations surrounding the user. In this example, the processing device may determine a current position and/or orientation of all or a portion of the user from the perspective of a different user that is viewing the user from a certain distance (e.g., from the stationary location within the physical environment). In some examples, determining the position and/or orientation may enable the artificial reality system to provide a remote view of the user to an additional user via a video conferencing or virtual room-sharing application. A transponder may be a passive transponder (e.g., an unpowered transponder) or an active transponder (e.g., a transponder having a power source that may allow amplification of one or more signals within the transponder).

Using one or more transponders, such as active transponders, a device may more quickly and precisely determine beat frequencies compared with a device that detects reflections from objects. For example, an active transponder may effectively behave as a point source that transmits a signal with excellent signal-to-noise properties and that may at least approximate a sinusoidal signal. Such a signal may enable faster and more accurate beat frequency and phase determinations than signals returned by, for example, reflection from an object.

In some examples, each transponder interrogated by the device may be configured to shift the frequency of signals returned to the device by a different amount, that may be termed an offset. For example, a first transponder may shift the frequency of a returned signal by 10 kilohertz and another transponder may shift the frequency of a returned signal by 20 kilohertz. The offset may be positive, which may correspond to a frequency increase of the beat signal. A transponder may shift the frequency of a returned signal using one or more of a variety of approaches, such as using a transponder circuit configured to shift the frequency of the transmitted signal received from a device by a certain amount before returning the transponder signal to the device. In some examples, a transponder may include a clock that provides a clock signal. The transponder signal may have an offset that may be related to the clock signal frequency. In some examples, the received RF signal may be mixed with a transponder clock frequency and a transponder signal having the sum frequency (e.g., of the transmitted signal frequency and the transponder clock frequency) may be returned to the device. The offset may be approximately equal to the clock frequency. In some examples, a difference signal (e.g., between the clock frequency and the radio frequency) may be returned to the device. In some examples, the offset may be adjustable, for example, by the device, other remote device or by settings on the transponder or wearable device on which it is located. In some examples, an offset frequency may be used to identify a user (e.g., a specific person, such as a particular player within a game).

In some examples, a transponder associated with a target may remain in a passive mode (e.g., an unpowered mode) until activated by a transmitted signal. This may allow different targets to be identified in succession. The energy requirements of the transponder may be reduced by reducing the proportion of the time that the transponder is active, that may be termed the interrogation time duty cycle. In some examples, one or more transponders may be activated at intervals for corresponding object distance measurement (that may be termed interrogation). In some examples, the determination of the absolute distance (using the beat frequency) and distance component (using the beat signal phase) may require less than 0.1 seconds and may be achieved in less than 1 millisecond. In some examples, interrogation may be completed in approximately 100 microseconds or less.

In some examples, the device may be configured to transmit a transmitted signal (e.g., a frequency-modulated RF signal) to a transponder (e.g., at least one transponder) located within the physical environment surrounding the user. The device may include a controller (that may include one or more processors) configured to direct the transponder to become active for a particular period of time. The active transponder may return a transponder signal to the device, detected as a received signal by the device. The controller may direct other transponders (e.g., within a plurality of transponders including the transponder and the other transponders) to be inactive during the particular period of time. The device may detect, while the transponder is active, a received signal returned to the device from the transponder in response to the transmitted signal and determine a beat signal (e.g., based on the received signal and a local oscillator signal). The device may determine an object distance between the transponder and the device using, for example, the frequency and/or phase of the beat signal. The device may then direct the transponder to become inactive and direct an additional transponder that was inactive during the particular period of time to become active for an additional period of time. The device may then determine an additional object distance for the additional transponder, for example, using the frequency and/or phase of a beat signal.

In some examples, power consumption may be reduced using one or more approaches, such as only powering the transponder when the transponder is used by the device. In some examples, a device may be configured to cycle through a plurality of transponders, for example, in sequence. An example device may be configured to: send an activation signal to a transponder (e.g., of a plurality of transponders), activating the transponder; send a transmitted signal to the transponder; receive a received signal including a transponder signal from the transponder; obtain a beat signal based on the transponder signal and a local oscillator; determine frequency and/or phase data from the beat signal; and send a deactivation signal to the transponder to deactivate the transponder. The device may then send a second activation signal to a second transponder and may repeat a similar process with one or more additional transponders.

In some examples, a transponder may harvest energy from the environment. Energy harvesting may occur at any time, for example, by obtaining energy from ambient electromagnetic fields (e.g., fields generated by the device, power distribution, radio signals, network signals or other transmitters, harvested using a detection coil, other antenna and one or more rectifiers), vibrations and mechanical stresses and strains (e.g., using piezoelectric materials or motion of magnets near electrical conductors, such as a coil), temperature gradients (e.g., using a Peltier device) or illumination (e.g., using a photovoltaic material). In some examples, a transponder may harvest energy from one or more transmitted RF signals and may harvest energy when the transponder is inactive. Harvested energy may include electrical charge that may be stored in a rechargeable battery, capacitor or other charge storage device. In some examples, the transmitted signal incident on an antenna of the transponder may be used to generate an electrical signal, that may be rectified and used to generate electrical energy stored in a charge storage device.

In some system configurations, not all of the transponders are active simultaneously. A device may provide an activation signal to a transponder, determine distance data related to the transponder and then deactivate the transponder. This process may be repeated (e.g., sequentially) for a plurality of transponders. The transponders may be inactive for periods of time, which reduces energy consumption of the transponder and may allow the transponder to be powered by energy harvesting. For example, a transponder may store energy obtained from electromagnetic fields, vibration, temperature differences, light or other ambient source of energy. In some examples, a device may transmit a power signal, received by the transponder and used to power the transponder. The power signal may include electromagnetic radiation at any suitable frequency.

A device may be configured to interrogate the transponders (or groups of transponders) at intervals, such as in sequence. Interrogation may include transmission of the transmitted beam and determination of absolute object distance from the beat frequency and determination of the distance component from phase measurements. The transponder may only be powered during interrogation. The device may also transmit a power signal, that may be used to convey energy to the transponder, for example, when the transponder is not being interrogated. In some examples, the device may transmit a power signal at a different frequency from the transmitted signal frequency. In some examples, the transmitted signal may act as the power signal for transponders in a passive mode and/or transponders not being interrogated by the transmitted signal. The transponder may include a charge storage device, such as a battery and/or capacitor, that may be charged by a power signal transmitted by the device, for example, using a charging circuit including an antenna, rectifier or other suitable components. In some examples, the charge storage device of a transponder may be charged by any suitable approach, for example, by harvesting energy from the environment.

An example wearable system may include a wearable artificial reality device, including at least one device configured to transmit a frequency-modulated RF signal and then receive at least one signal returned from a target that received the frequency-modulated RF signal. The wearable system may include a controller that is communicatively coupled to the device. This controller (that may include one or more processors) may be configured to determine the beat frequency and then determined, based at least in part on the beat frequency, the object distance (e.g., the distance between the target, such as a transponder and the device).

In some example, a wearable device such as a headset may communicate wirelessly with a portable computer (that may also have other functions, such as a table, phone or other device). Any suitable frequency (e.g., approximately 60 GHz) may be used for communication between the portable computer and the wearable device. In some examples, a system may include a device secured to a wearable device dimensioned to be worn by a user of an artificial reality system, such as a headset, wristband, glove or other wearable device.

In some examples, a system may include a headset. The headset may include one or more devices or a device with one or more transmitters and/or receivers. In some examples, a device may include different receivers tuned to different frequency ranges that may detect signals from different transponders. An example headset may be a component of an augmented reality system or a virtual reality system. In some examples, a headset may include at least 3 RF transmitters and the 3 object distances determined using each RF transmitter may be used to determine a 3D location of the object. In some examples, the 3 distance component measurements made using respective beat signal phase measurements may be used to track the object in 3D with micron-scale precision (e.g., with a distance precision of less than 10 microns).

In some examples, an augmented reality or virtual reality (AR/VR) system may include one or more RF transmitters. An example headset may include one or more RF transmitters. A headset may support or otherwise include one or more other sensors that may help locate objects relative to the headset (or to other reference points). A headset may include an image sensor configured to find a relative location of body parts (and/or the location of transponders located on the body parts) relative to the headset. In some examples, a transponder may include a visually discernable identifying mark, such as a code or graphic.

In some examples, one or more devices, each device including one or more RF transmitters, may be used to obtain 3D localization of an object. The location of the object may be determined using one or more distances determined by an example device as described herein, and may also use additional information such as data from other sensors, such as image sensors. In some examples, a musculoskeletal model of a person may be used to constrain location estimates for an object.

In some examples, a device may further include at least one electronic display configured to show a virtual reality image and/or an augmented reality image that includes a representation of the object. The virtual location of the virtual representation of the object within the virtual reality image (or location within an augmented reality image) may be based, at least in part, on one or more object distances determined using a device.

In some examples, a device may include a controller configured to determine the location of the object based on object distances determined using one or more RF transmitters and/or devices. The distance from the device to an object may be referred to as the object distance, target distance, target range or range.

A device may determine distance data related to at least one transponder. A device may also be used to detect other objects in the environment, such as obstacles, steps or other hazards associated with the floor or other aspect of the local physical environment. Transponders may be associated with hazards and may be referred to as hazard transponders. An alert may be provided to a user if the user approaches within a threshold distance of a hazard transponder.

One or more transponders may be associated with another human (e.g., a child) or an animal (e.g., a dog, cat or other pet) that may move into or within the local physical environment and thereby cause a hazard, such as a tripping hazard.

RF transmitters, receivers and/or devices may be arranged in a spaced apart and/or non-coplanar arrangement (e.g., on a headset) to facilitate three-dimensional localization of an object, such as a transponder, based on one or more object distance measurements and optionally other sensor data. In some examples, an example device (such as described herein) may be used to accurately locate the eyes of the user relative to the environment, and the environment may include one or more reference locations that may also be located using the example device. This or similar approaches may be used to improve the accuracy of a user perspective view presented to the user within an augmented or virtual reality environment using one or more display devices.

In some examples, an augmented/virtual reality system may also be configured to provide a view of the user, using data related to the distance between a device (e.g., a headset supported device) and one or more transponders that are fixed within the environment. For example, a transponder associated with a fixed item within the local physical environment of the user may be termed a reference transponder.

In some examples, interference between transmitter and receiver may be reduced, for example, using a transmitted signal having a first polarization and a received signal having a second polarization, different from the first polarization. This may reduce noise and clutter. For example, the transponder may be configured to return a transponder signal having a different polarization from the transmitted signal incident on the transponder. Examples may include use of first and second polarizations corresponding to, respectively, orthogonal planar polarizations, circular and linear polarization (or vice versa), circular polarizations having different handedness or elliptical polarizations of different parameters. The use of circular polarization for the transmitted signal and/or the received signal may impart one or more advantages such as reduced noise, reduced orientation effects related to target motion, facilitation of higher gain and may impart other advantages.

In some examples, a system may include one or more devices, one or more transponders and (optionally) one or more repeaters configured to amplify an RF signal. A repeater may be used to amplify a transmitted signal, a transponder signal or both. In some examples, a repeater may be located on another side (e.g., an opposite side) of a body part (or other item) relative to a transponder and may be used to compensate for RF signal absorption by a person or other item. One or more repeaters may be used to reduce noise in the received signal.

In some examples, a device may provide a precise location of an object, with sub-millimeter or, in some examples, micron-scale precision. Example devices may identify gestures. In some examples, gestures may be identified using sub-millimeter (e.g., micron-scale) motions of the hand or one or more fingers of the user, which may be detected using changes in the phase of the beat signal.

An example method may include detecting an intended user input (e.g., to a computer system) from movements of the object (e.g., a finger or portion thereof or a transponder associated with a finger or portion thereof). For example, a computerized system may display a virtual user input device (such as a keyboard, keypad, joystick, mouse or other input device) to a user. A person may enter a user input using a movement detected using a beat frequency phase measurement. This movement may be visually imperceptible to a remote viewer. Movements (e.g., of a body part such as a finger) may be on the order of microns and may be detected using the beat frequency phase measurement. Visual feedback may be presented to the user, using a display, to indicated successful provision of the intended user input to the device or system. User inputs may include selection of an virtual or real object in a virtual or augmented reality environment, data entry (such as alphanumeric data entry), selection of menu items or virtual keyboard use.

In some examples, a computer-implemented method may include determining a distance to an object by determining the beat frequency and the phase of a beat signal. The beat signal may be formed using a detected RF signal and a local oscillator and the local oscillator may be based on a transmitted RF signal. The beat frequency may be determined from the time separation between zero crossing times of the beat signal. The phase may be determined based on an amplitude of the beat signal at a particular measurement time. A non-transitory computer-readable medium may include one or more computer-executable instructions that, when executed by at least one processor of a computing device, cause the computing device to: determine the distance to an object by determining the beat frequency and the phase of a beat signal, as described herein.

A method, such as a computer-implemented method, may further include determining an object location using one or more distance measurements. A virtual reality environment may then be rendered, including a virtual representation of the object having a virtual location within the virtual reality environment based, at least in part, on one or more object distance determination made using a device. In some examples, an augmented reality representation of the object may be displayed having a location based, at least in part, on one or more object distance determination made using a device. A method may further include tracking an object using a plurality of distance measurements made at different times. The tracking of an object motion may be used to modify a virtual representation of an object or to detect an intended use input into a computerized device.

In some examples, a system may include at least one physical processor and physical memory including computer-executable instructions that, when executed by the physical processor, cause the physical processor to determine a distance to an object using a received RF signal, such as a transponder signal. and use the distance in an augmented or virtual reality display of a user environment.

Applications may include augmented reality, virtual reality, user input devices (e.g., using hand-tracking, finger-tracking and/or gesture detection to determine an intended user input to a device), autonomous vehicles, robots (e.g., a robot for which a micron-scale distance precision measurements may be advantageous) or other device. In some examples, a device may be associated with an element (e.g., a separate RF transmitter, drone, vehicle, robot, person or other element) and distance changes between pairs (or other combinations) of elements may be monitored. Corrective movements of the elements may be induced or suggested to maintain a desired spacing or relative position between the elements. Example approaches may be used to maintain an approximately constant spacing between transmitter elements, which may then function in the manner of a synthetic aperture radar. Example approaches may also be used to maintain an approximately constant or monitor spacing between arrays of sensors.

Examples include improved methods of tracking, such as hand tracking within an AR/VR system and improved tracker devices. In some examples, a device generates a transmitted signal (e.g., a transmitted RF signal, such as a transmitted radar signal) having a time-dependent frequency, and the device may then detect a returned signal from an object in response to the RF signal being incident on the object. The beat frequency (e.g., the frequency difference between the transmitted signal and received signal when the received signal is detected at the device) may be used to determine an absolute object distance, which may have approximately millimeter-scale accuracy. Further, detecting phase changes in the beat signal may allow relative distance changes to be detected with greater precision, such as up to micron-scale precision. A tracked object may include a body part or any other object, such as one or multiple transponders mounted on a body part such as a hand or wrist. Distance measurements may be made within a small fraction of a millisecond, for example, by measuring the time between zero crossings to determine the beat frequency. Amplitude variations in the beat signal may be used to determine phase changes. In some examples, described approaches facilitate energy harvesting by the transponder, as the interrogation time becomes very short and a larger proportion of time can be used to harvest energy (e.g., from the transmitted signal or from the environment).

In some examples, distance measurement accuracy may be improved by increasing the beat frequency by a predetermined frequency shift that may be introduced using, for example, an artificially time-delayed transmitted frequency signal to increase the beat frequency.

### EXAMPLE EMBODIMENTS

Example 1. An example device may include: a transmitter configured to transmit a transmitted radio frequency (RF) signal; a receiver configured to detect a received RF signal in response to the transmitted RF signal being incident on an object, the receiver including a mixer configured to provide a beat signal based on the received RF signal and a local oscillator signal; and a controller configured to determine: a beat frequency of the beat signal; a beat signal phase of the beat signal; and an object distance between the device and the object using the beat frequency and the beat signal phase.

Example 2. The device of example 1, wherein the local oscillator signal is based on the transmitted RF signal.

Example 3. The device of any of examples 1 and 2, wherein the beat frequency is based on a frequency difference between the transmitted RF signal and the received RF signal when the received RF signal is detected.

Example 4. The device of any of examples 1-3, wherein the transmitter includes a frequency ramp generator.

Example 5. The device of any of examples 1-4, wherein the transmitted RF signal includes a time-dependent linear frequency ramp.

Example 6. The device of any of examples 1-5, wherein the controller is further configured to determine: an absolute distance to the object using the beat frequency, a distance component to the object using the beat signal phase, and the object distance based on the absolute distance and the distance component.

Example 7. The device of any of examples 1-6, wherein the absolute distance has a linear dependence on the beat frequency.

Example 8. The device of any of examples 1-7, wherein the controller is configured to determine the beat signal phase based on an amplitude measurement of the beat signal.

Example 9. The device of any of examples 1-8, wherein the controller is configured to detect a change in the object distance of less than 10 microns using the beat signal phase.

Example 10. The device of any of examples 1-9, wherein the receiver includes an analog-to-digital converter configured to provide the beat signal to the controller as a digitized beat signal.

Example 11. The device of any of examples 1-10, wherein the controller includes at least one processor configured to determine the beat frequency and the beat signal phase.

Example 12. The device of any of examples 1-11, wherein the controller is configured to determine the beat frequency based on a time interval between threshold crossings of the beat signal.

Example 13. The device of any of examples 1-12, wherein the threshold crossings of the beat signal include zero crossings of the beat signal.

Example 14. The device of any of examples 1-13, wherein the controller is configured to determine a location of the object based on a plurality of distances to the object determined using a plurality of transmitters including the transmitter.

Example 15. The device of any of examples 1-14, wherein the device includes a headset and the transmitter is located on the headset.

Example 16. The device of any of examples 1-15, wherein the device is a component of a virtual reality system configured to show a virtual reality environment including a virtual representation of the object, and the virtual representation of the object has a virtual location within the virtual reality environment based, at least in part, on the object distance.

Example 17. An example method may include transmitting a transmitted RF signal to a transponder associated with an object; receiving a received RF signal from the transponder associated with the object; forming a beat signal using the received RF signal and a local oscillator signal; determining an absolute distance to the object based on at least one time interval between threshold crossings of the beat signal; determining a distance component to the object based on a phase measurement of the beat signal; and determining an object distance to the object using the absolute distance and the distance component.

Example 18. The method of example 17, further including: displaying a representation of the object at a location within a virtual reality or augmented reality environment, wherein the location of the representation of the object is based, at least in part, on the object distance.

Example 19. An example method may include: transmitting a transmitted RF signal from a device to an object, the transmitted RF signal including a linear frequency ramp; receiving a received RF signal from the object at the device; forming a beat signal between the received RF signal and a local oscillator signal; determining a phase of the beat signal; and detecting a movement of the object based on a change in the phase of the beat signal, wherein the local oscillator signal is based on the transmitted RF signal.

Example 20. The method of any of examples 17-19, wherein the object includes a transponder supported on a body part of a user, and the method further includes identifying an input to a computerized device based, at least in part, on the movement of the object.

Embodiments of the present disclosure may include or be implemented in conjunction with various types of artificial reality systems. Artificial reality is a form of reality that has been adjusted in some manner before presentation to a user, that may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of that may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial reality systems may be designed to work without near-eye displays (NEDs). Other artificial reality systems may include an NED that also provides visibility into the real world (such as, e.g., augmented-reality system 1400 in FIG. 14) or that visually immerses a user in an artificial reality (such as, e.g., virtual-reality system 1500 in FIG. 15). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 14, augmented-reality system 1400 may include an eyewear device 1402 with a frame 1410 configured to hold a left display device 1415(A) and a right display device 1415(B) in front of a user's eyes. Display devices 1415(A) and 1415(B) may act together or independently to present an image or series of images to a user. While augmented-reality system 1400 includes two displays, embodiments of this disclosure may be implemented in augmented-reality systems with a single NED or more than two NEDs.

In some embodiments, augmented-reality system 1400 may include one or more sensors, such as sensor 1440. Sensor 1440 may generate measurement signals in response to motion of augmented-reality system 1400 and may be located on substantially any portion of frame 1410. Sensor 1440 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1400 may or may not include sensor 1440 or may include more than one sensor. In embodiments in which sensor 1440 includes an IMU, the IMU may generate calibration data based on measurement signals from sensor 1440. Examples of sensor 1440 may include, without limitation, accelerometers, gyroscopes, magnetometers, other suitable types of sensors that detect motion, sensors used for error correction of the IMU, or some combination thereof.

In some examples, augmented-reality system 1400 may also include a microphone array with a plurality of acoustic transducers 1420(A)-1420(J), referred to collectively as acoustic transducers 1420. Acoustic transducers 1420 may represent transducers that detect air pressure variations induced by sound waves. Each acoustic transducer 1420 may be configured to detect sound and convert the detected sound into an electronic format (e.g., an analog or digital format). The microphone array in FIG. 14 may include, for example, ten acoustic transducers: 1420(A) and 1420(B), that may be designed to be placed inside a corresponding ear of the user, acoustic transducers 1420(C), 1420(D), 1420(E), 1420(F), 1420(G), and 1420(H), that may be positioned at various locations on frame 1410, and/or acoustic transducers 1420(1) and 1420(J), that may be positioned on a corresponding neckband 1405.

In some embodiments, one or more of acoustic transducers 1420(A)-(J) may be used as output transducers (e.g., speakers). For example, acoustic transducers 1420(A) and/or 1420(B) may be earbuds or any other suitable type of headphone or speaker.

The configuration of acoustic transducers 1420 of the microphone array may vary. While augmented-reality system 1400 is shown in FIG. 14 as having ten acoustic transducers 1420, the number of acoustic transducers 1420 may be greater or less than ten. In some embodiments, using higher numbers of acoustic transducers 1420 may increase the amount of audio information collected and/or the sensitivity and accuracy of the audio information. In contrast, using a lower number of acoustic transducers 1420 may decrease the computing power required by an associated controller 1450 to process the collected audio information. In addition, the position of each acoustic transducer 1420 of the microphone array may vary. For example, the position of an acoustic transducer 1420 may include a defined position on the user, a defined coordinate on frame 1410, an orientation associated with each acoustic transducer 1420, or some combination thereof.

Acoustic transducers 1420(A) and 1420(B) may be positioned on different parts of the user's ear, such as behind the pinna, behind the tragus, and/or within the auricle or fossa. Or, there may be additional acoustic transducers 1420 on or surrounding the ear in addition to acoustic transducers 1420 inside the ear canal. Having an acoustic transducer 1420 positioned next to an ear canal of a user may enable the microphone array to collect information on how sounds arrive at the ear canal. By positioning at least two of acoustic transducers 1420 on either side of a user's head (e.g., as binaural microphones), augmented-reality device 1400 may simulate binaural hearing and capture a 3D stereo sound field around about a user's head. In some embodiments, acoustic transducers 1420(A) and 1420(B) may be connected to augmented-reality system 1400 via a wired connection 1430, and in other embodiments acoustic transducers 1420(A) and 1420(B) may be connected to augmented-reality system 1400 via a wireless connection (e.g., a BLUETOOTH connection). In still other embodiments, acoustic transducers 1420(A) and 1420(B) may not be used at all in conjunction with augmented-reality system 1400.

Acoustic transducers 1420 on frame 1410 may be positioned in a variety of different ways, including along the length of the temples, across the bridge, above or below display devices 1415(A) and 1415(B), or some combination thereof. Acoustic transducers 1420 may also be oriented such that the microphone array is able to detect sounds in a wide range of directions surrounding the user wearing the augmented-reality system 1400. In some embodiments, an optimization process may be performed during manufacturing of augmented-reality system 1400 to determine relative positioning of each acoustic transducer 1420 in the microphone array.

In some examples, augmented-reality system 1400 may include or be connected to an external device (e.g., a paired device), such as neckband 1405. Neckband 1405 generally represents any type or form of paired device. Thus, the discussion of neckband 1405 may also apply to various other paired devices, such as charging cases, smart watches, smart phones, wrist bands, other wearable devices, hand-held controllers, tablet computers, laptop computers, other external compute devices, etc.

As shown, neckband 1405 may be coupled to eyewear device 1402 via one or more connectors. The connectors may be wired or wireless and may include electrical and/or non-electrical (e.g., structural) components. In some cases, eyewear device 1402 and neckband 1405 may operate independently without any wired or wireless connection between them. While FIG. 14 illustrates the components of eyewear device 1402 and neckband 1405 in example locations on eyewear device 1402 and neckband 1405, the components may be located elsewhere and/or distributed differently on eyewear device 1402 and/or neckband 1405. In some embodiments, the components of eyewear device 1402 and neckband 1405 may be located on one or more additional peripheral devices paired with eyewear device 1402, neckband 1405, or some combination thereof.

Pairing external devices, such as neckband 1405, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1400 may be provided by a paired device or shared between a paired device and an eyewear device, thus reducing the weight, heat profile, and form factor of the eyewear device overall while still retaining desired functionality. For example, neckband 1405 may allow components that would otherwise be included on an eyewear device to be included in neckband 1405 since users may tolerate a heavier weight load on their shoulders than they would tolerate on their heads. Neckband 1405 may also have a larger surface area over which to diffuse and disperse heat to the ambient environment. Thus, neckband 1405 may allow for greater battery and computation capacity than might otherwise have been possible on a stand-alone eyewear device. Since weight carried in neckband 1405 may be less invasive to a user than weight carried in eyewear device 1402, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 1405 may be communicatively coupled with eyewear device 1402 and/or to other devices. These other devices may provide certain functions (e.g., tracking, localizing, depth mapping, processing, storage, etc.) to augmented-reality system 1400. In the embodiment of FIG. 14, neckband 1405 may include two acoustic transducers (e.g., 1420(1) and 1420(J)) that are part of the microphone array (or potentially form their own microphone subarray). Neckband 1405 may also include a controller 1425 and a power source 1435.

Acoustic transducers 1420(1) and 1420(J) of neckband 1405 may be configured to detect sound and convert the detected sound into an electronic format (analog or digital). In the embodiment of FIG. 14, acoustic transducers 1420(1) and 1420(J) may be positioned on neckband 1405, thereby increasing the distance between the neckband acoustic transducers 1420(1) and 1420(J) and other acoustic transducers 1420 positioned on eyewear device 1402. In some cases, increasing the distance between acoustic transducers 1420 of the microphone array may improve the accuracy of beamforming performed via the microphone array. For example, if a sound is detected by acoustic transducers 1420(C) and 1420(D) and the distance between acoustic transducers 1420(C) and 1420(D) is greater than, for example, the distance between acoustic transducers 1420(D) and 1420(E), the determined source location of the detected sound may be more accurate than if the sound had been detected by acoustic transducers 1420(D) and 1420(E).

Controller 1425 of neckband 1405 may process information generated by the sensors on neckband 1405 and/or augmented-reality system 1400. For example, controller 1425 may process information from the microphone array that describes sounds detected by the microphone array. For each detected sound, controller 1425 may perform a direction-of-arrival (DOA) estimation to estimate a direction from which the detected sound arrived at the microphone array. As the microphone array detects sounds, controller 1425 may populate an audio data set with the information. In embodiments in which augmented-reality system 1400 includes an inertial measurement unit, controller 1425 may compute all inertial and spatial calculations from the IMU located on eyewear device 1402. A connector may convey information between augmented-reality system 1400 and neckband 1405 and between augmented-reality system 1400 and controller 1425. The information may be in the form of optical data, electrical data, wireless data, or any other transmittable data form. Moving the processing of information generated by augmented-reality system 1400 to neckband 1405 may reduce weight and heat in eyewear device 1402, making it more comfortable to the user.

Power source 1435 in neckband 1405 may provide power to eyewear device 1402 and/or to neckband 1405. Power source 1435 may include, without limitation, lithium ion batteries, lithium-polymer batteries, primary lithium batteries, alkaline batteries, or any other form of power storage. In some cases, power source 1435 may be a wired power source. Including power source 1435 on neckband 1405 instead of on eyewear device 1402 may help better distribute the weight and heat generated by power source 1435.

As noted, some artificial reality systems may, instead of blending an artificial reality with actual reality, substantially replace one or more of a user's sensory perceptions of the real world with a virtual experience. One example of this type of system is a head-worn display system, such as virtual-reality system 1500 in FIG. 15, that mostly or completely covers a user's field of view. Virtual-reality system 1500 may include a front rigid body 1502 and a band 1504 shaped to fit around a user's head. Virtual-reality system 1500 may also include output audio transducers 1506(A) and 1506(B). Furthermore, while not shown in FIG. 15, front rigid body 1502 may include one or more electronic elements, including one or more electronic displays, one or more inertial measurement units (IMUS), one or more tracking emitters or detectors, and/or any other suitable device or system for creating an artificial-reality experience.

Artificial reality systems may include a variety of types of visual feedback mechanisms. For example, display devices in augmented-reality system 1400 and/or virtual-reality system 1500 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial reality systems may include a single display screen for both eyes or may provide a display screen for each eye, that may allow for additional flexibility for varifocal adjustments or for correcting a user's refractive error. Some of these artificial reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial reality systems described herein may include one or more projection systems. For example, display devices in augmented-reality system 1400 and/or virtual-reality system 1500 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial reality systems may also be configured with any other suitable type or form of image projection system, such as retinal projectors used in virtual retina displays.

The artificial reality systems described herein may also include various types of computer vision components and subsystems. For example, augmented-reality system 1400 and/or virtual-reality system 1500 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

The artificial reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial reality systems described herein may also include tactile (i.e., haptic) feedback systems, that may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial reality experience in one or more of these contexts and environments and/or in other contexts and environments.

Some augmented reality systems may map a user's and/or device's environment using techniques referred to as “simultaneous location and mapping” (SLAM). SLAM mapping and location identifying techniques may involve a variety of hardware and software tools that can create or update a map of an environment while simultaneously keeping track of a user's location within the mapped environment. SLAM may use many different types of sensors to create a map and determine a user's position within the map, including devices as described herein, and in some examples, devices in combination with other sensors.

SLAM techniques may, for example, implement radar and/or optical sensors to determine a user's location. Radios including WiFi, BLUETOOTH, global positioning system (GPS), cellular or other communication devices may be also used to determine a user's location relative to a radio transceiver or group of transceivers (e.g., a WiFi router or group of GPS satellites). Acoustic sensors such as microphone arrays or 2D or 3D sonar sensors may also be used to determine a user's location within an environment. Augmented reality and virtual reality devices (such as systems 1400 and 1500 of FIGS. 14 and 15, respectively) may incorporate any or all of these types of sensors to perform SLAM operations such as creating and continually updating maps of the user's current environment. In at least some of the embodiments described herein, SLAM data generated by these sensors may be referred to as “environmental data” and may indicate a user's current environment. This data may be stored in a local or remote data store (e.g., a cloud data store) and may be provided to a user's AR/VR device on demand.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed (such as a beat signal), transform the data, output a result of the transformation to perform a function, use the result of the transformation to perform a function, and store the result of the transformation to perform a function. The function may include the control of a device, or determination of an object location. Data may include data associated with one or more of the transmitted signal, received signal, local oscillator signal, beat signal, object distance, object location, object movement, or other data. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a transmitter configured to transmit a transmitted radio frequency (RF) signal;
a receiver configured to detect a received RF signal in response to the transmitted RF signal being incident on an object, the receiver comprising a mixer configured to provide a beat signal based on the received RF signal and a local oscillator signal; and
a controller configured to determine:
a beat frequency of the beat signal;
a beat signal phase of the beat signal; and
an object distance between the device and the object using the beat frequency and the beat signal phase.

2. The device of claim 1, wherein the local oscillator signal is based on the transmitted RF signal.

3. The device of claim 1, wherein the beat frequency is based on a frequency difference between the transmitted RF signal and the received RF signal when the received RF signal is detected.

4. The device of claim 1, wherein the transmitter includes a frequency ramp generator.

5. The device of claim 4, wherein the transmitted RF signal includes a time-dependent linear frequency ramp.

6. The device of claim 1, wherein the controller is further configured to determine:
an absolute distance to the object using the beat frequency,
a distance component to the object using the beat signal phase, and
the object distance based on the absolute distance and the distance component.

7. The device of claim 6, wherein the absolute distance has a linear dependence on the beat frequency.

8. The device of claim 1, wherein the controller is configured to determine the beat signal phase based on an amplitude measurement of the beat signal.

9. The device of claim 1, wherein the controller is configured to detect a change in the object distance of less than 10 microns using the beat signal phase.

10. The device of claim 1, wherein the receiver includes an analog-to-digital converter configured to provide the beat signal to the controller as a digitized beat signal.

11. The device of claim 10, wherein the controller includes at least one processor configured to determine the beat frequency and the beat signal phase.

12. The device of claim 1, wherein the controller is configured to determine the beat frequency based on a time interval between threshold crossings of the beat signal.

13. The device of claim 12, wherein the threshold crossings of the beat signal include zero crossings of the beat signal.

14. The device of claim 1, wherein the controller is configured to determine a location of the object based on a plurality of distances to the object determined using a plurality of transmitters including the transmitter.

15. The device of claim 1, wherein the device includes a headset and the transmitter is located on the headset.

16. The device of claim 1, wherein
the device is a component of a virtual reality system configured to show a virtual reality environment including a virtual representation of the object, and
the virtual representation of the object has a virtual location within the virtual reality environment based, at least in part, on the object distance.

17. A method, comprising:
transmitting a transmitted RF signal to a transponder associated with an object;
receiving a received RF signal from the transponder associated with the object;
forming a beat signal using the received RF signal and a local oscillator signal;
determining an absolute distance to the object based on at least one time interval between threshold crossings of the beat signal;
determining a distance component to the object based on a phase measurement of the beat signal; and
determining an object distance to the object using the absolute distance and the distance component.

18. The method of claim 17, further comprising:
displaying a representation of the object at a location within a virtual reality or augmented reality environment, wherein
the location of the representation of the object is based, at least in part, on the object distance.

19. A method, comprising:
transmitting a transmitted RF signal from a device to an object, the transmitted RF signal including a linear frequency ramp;
receiving a received RF signal from the object at the device;
forming a beat signal between the received RF signal and a local oscillator signal;
determining a phase of the beat signal; and
detecting a movement of the object based on a change in the phase of the beat signal,
wherein the local oscillator signal is based on the transmitted RF signal.

20. The method of claim 19, wherein the object includes a transponder supported on a body part of a user, the method further comprising:
identifying an input to a computerized device based, at least in part, on the movement of the object.
